(19) United States
(12) Patent Application Publication
(10) Pub. No.: US 2015/0220300 A1
(43) Pub. Date: Aug. 6, 2015

(54) SYSTEMS AND METHODS FOR CONFIGURING A VIDEO WALL

(71) Applicant: TV One Limited, Margate (GB)

(72) Inventors: David Reynaga, Maidenhead (GB); Darren Carson, Margate (GB); Tony McAhren, Erlanger, KY (US); Tim Moore, Margate (GB)

(21) Appl. No.: 14/612,490

(22) Filed: Feb. 3, 2015

Related U.S. Application Data
(60) Provisional application No. 61/935,220, filed on Feb. 3, 2014.

(51) Int. Cl. G06F 3/14; H04N 7/08

(52) U.S. Cl. CPC G06F 3/1446; G06F 3/1431; H04N 7/0806

(57) ABSTRACT

Systems and methods can be used to configure a video wall in real-time. A video canvas object can be configured by a computing device. A command indicative of the configuration of the video canvas object can be received by a video processor separate from and communicatively connected to the computing device. A video canvas can be configured by the video processor in accord with the command such that the video canvas appears as the video canvas object appears on the computing device.

### CLAIM OF PRIORITY

This Application claims the benefit of priority to U.S. Provisional Application No. 61/935,220, filed Feb. 3, 2014, the entire content of which being incorporated herein by reference.

### BACKGROUND

A video wall includes a number of video sources displayed on a number of video display devices (e.g., Liquid Crystal Display (LCD) or Light Emitting Diode (LED) television or other monitors). For example, a video wall can include two or more monitors, screens, or other displays, receiving the same video source such that the multiple displays appear as a single display. In another example, multiple video sources can be transmitted to a single video display, such as a projector screen. Video walls can be found on Wall Street, in airports, stadiums, bars, newsrooms, control rooms, libraries, and other locations.

A video wall can provide the ability to customize a viewing experience in ways that a single display setup cannot provide. For example, a video wall can be configured in a variety of shapes, sizes, and geometrical configurations. A video wall can provide greater screen area per unit cost or greater pixel density per unit cost as compared to a single display setup.

### BRIEF DESCRIPTION OF THE DRAWINGS

Aspects of the present disclosure are illustrated by way of example and are not limited by the accompanying FIGS. with like references indicating like elements.

FIG. 1 illustrates a block diagram of an example of a system for configuring a video wall in real-time.

FIG. 2 illustrates a block diagram of an example of a Graphical User Interface (GUI) of a program for configuring a video canvas setup.

FIG. 3 illustrates a block diagram of an example of the GUI which includes a canvas box on which a video canvas configuration can be created.

FIG. 4 illustrates a block diagram of an example of the GUI of FIG. 3 with a display object situated on the video canvas box.

FIG. 5 illustrates a block diagram of an example of a configuration screen including inputs for configuring a display object on the canvas.

FIG. 6 illustrates a block diagram of an example of the GUI of FIG. 4 with a source object situated on the display object.

FIG. 7 illustrates a block diagram of an example of the GUI after the source object has been activated or selected.

FIG. 8 illustrates a block diagram of an example of a configuration screen including inputs for configuring a source object in the video canvas box.

FIG. 9 illustrates a block diagram of an example of the GUI including a single display object and four source objects situated on the display object.

FIG. 10 illustrates a block diagram of an example of the GUI including four display objects on the video canvas configuration box.

FIG. 11 illustrates a block diagram of the example GUI of FIG. 10 with a single source object spanning all four display objects.

FIG. 12 illustrates a block diagram of the GUI with four rotated display objects including a source object over at least a portion of each of the display objects.

FIG. 13 illustrates a block diagram of the example GUI of FIG. 12 with the source object displaying video.

FIG. 14 illustrates a block diagram of an example of a GUI dashboard.

FIG. 15 illustrates a block diagram of the example of the GUI dashboard of FIG. 14 with a different video canvas object selected.

FIG. 16 illustrates a block diagram of an example of a video processor.

FIG. 17 illustrates a flow diagram of an example of a technique.

FIG. 18 illustrates a block diagram of an example of a computer system.

### DETAILED DESCRIPTION

The speed at which video source(s) transmitted to a video wall can be altered and implemented on the video wall can be increased by including a dedicated video processor that is configured to receive configuration commands from a video wall configuration software client computer, and process the configuration commands into video output data that may be transmitted to the display(s) on the video wall. By separating the processing done at the video processor from the computer on which the video wall configuration software client is operating, an architecture that receives and quickly executes commands can be created. In some examples in which a client video wall configuration software client computer is coupled with a dedicated video processor device, real-time or near real-time changes can be made to a video wall. A time between receipt of a command and implementation of the change associated with the command on a video wall can be on the order of a fraction of a millisecond.

In examples according to this disclosure, “real-time,” “near real-time,” “live,” changes to a video wall may refer to changes that are made with little to no appreciable effect on the quality or effectively persistent display of video source(s) on the video wall. In other words, “real-time,” “near real-time,” “live,” changes to a video wall may refer to changes that appear or are perceived as instantaneous to viewers of the video wall.

In this disclosure, an actual video wall including one or more video sources displayed thereon by one or more displays is referred to as a “video canvas.” The creation of a virtual video wall configuration (e.g., number of video sources and output displays, spatial arrangement, size, resolution, etc.) is referred to as a “video canvas object,” which can include one or more video source objects or one or more video display objects.

Examples according to this disclosure include software that can be used to configure and control, in real-time, a video canvas including one or more video sources displayed on one or more display devices. The video wall configuration software can be communicatively connected to a high-performance video processor device, which is connected to the video source(s) as input(s) and to the display device(s) as output(s). The configuration software can include a graphical user interface (GUI), which allows easy and feature rich editing of an electronic representation of an actual video canvas, referred to as a video canvas object that includes representations of the sources as video source objects and the display devices as video display objects. The configuration of individual source and display objects, as well as the video canvas object can be performed with the benefit of all the functional and graphical benefits of computer-based software applications, but the video processor can implement the video canvas configuration created by the software and changes to such configuration in real-time.

In one example, the video wall configuration software is employed to create a video canvas object representative of an actual video canvas. The video canvas object includes a single video display object which is configured to display multiple video source objects. For example, the display object can be representative of a large projector screen which displays multiple video source objects (e.g., a sporting event, a newscast, and a music video). The video wall configuration software can change the arrangement of the video source objects (e.g., where each source is spatially arranged on the projector screen or changing the orientation of one or more of the source objects by rotating the source object relative to the display object). Additionally, the software can be used to change the settings of the video display object (e.g., resolution, contrast, brightness, and other video and/or audio settings for a particular type of video display). When the video canvas object is configured and when any changes are made to the configuration, the video wall configuration software can transmit configuration commands to the video processor device, which, in turn, can process actual video data (e.g., pixel data to implement the configuration of sources and displays on the actual video canvas).

In examples according to this disclosure, because the configuration and video processing is divided between computer and a high-performance, dedicated video processor, users of the video wall configuration software have the benefit of a graphics and feature rich interface for configuring and controlling video canvases and audiences will enjoy dynamic video presentations that can be changed and updated live where such changes and updates appear virtually instantaneous.

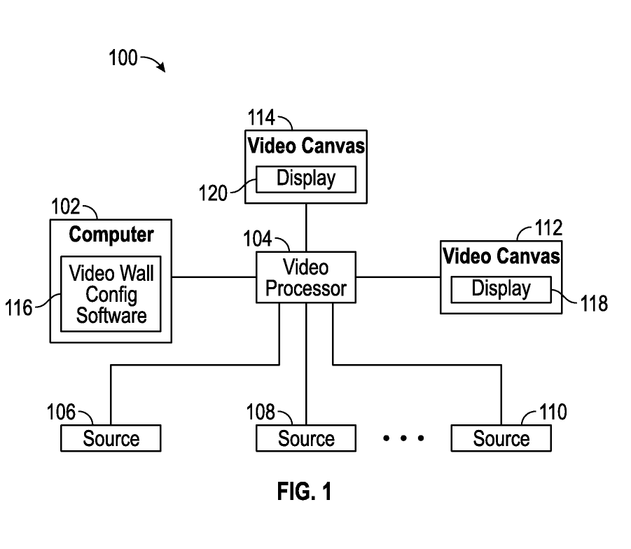

FIG. 1 illustrates an example of a system 100 for configuring one or more video canvases 112 or 114, such as in real-time. The system 100 can include a computer 102 coupled to a video processor 104. One or more sources 106, 108, or 110 can be inputs to the video processor 104. The video processor 104 can configure one or more video canvases 112 or 114 as a function of the source 106, 108, or 110 and input from video wall configuration software 116. Each video canvas 112, 114, etc. can include one or more video display devices (e.g., displays 118 and 120 of video canvases 112 and 114, respectively). Although only two canvases are illustrated, more are possible. Additionally, each video canvas can include one or more displays. The video processor 104 can be separate from and communicatively coupled to the computing device 102.

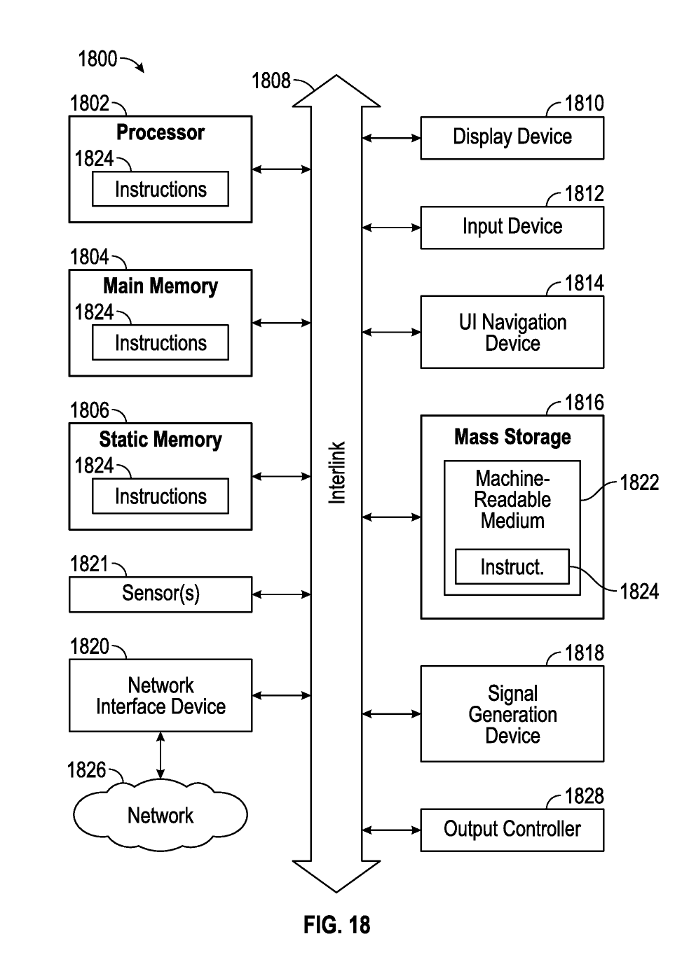

The computer 102 can include components or operate similar to the example machine 1800 as shown in FIG. 18. The computer 102 can include video wall configuration software 116 stored thereon or otherwise available, such as over the internet or other network, to operate thereon or therethorugh. The computer 102 can be coupled to the video processor 104, such as through a wired or wireless connection. The computer 102 can transmit commands, such as text data, to the video processor 104 through the wired or wireless connection. The text commands can be produced by the video wall configuration software 116 in accord with input from a user operating the video wall configuration software 116.

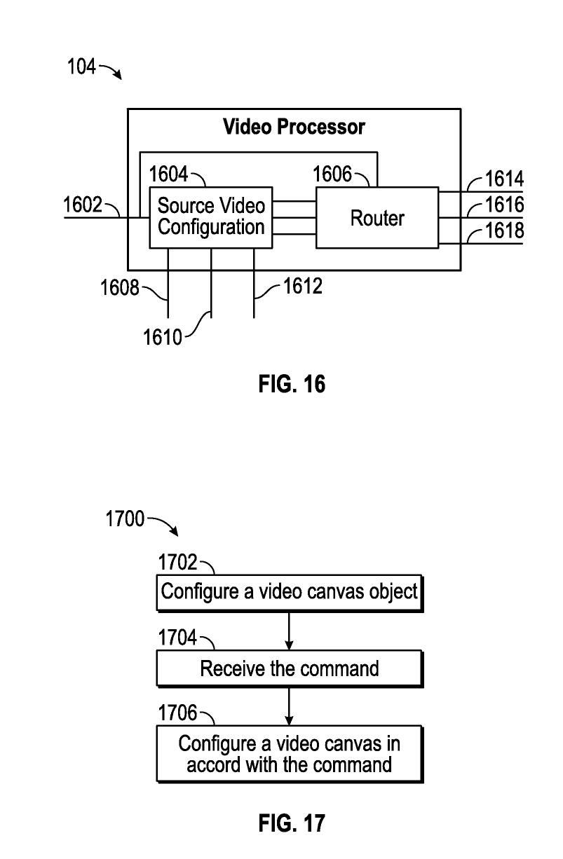

The video processor 104 can receive the commands from the computer 102. The video processor 104 can route the source 106, 108, or 110 to the display(s) 118 or 120 of the video canvases 112 or 114. The configuration (e.g., size, shape, orientation (e.g., location or rotation), intensity, contrast, aspect ratio, color, etc.) of the source 106, 108, or 110 video data can be altered as a function of a command created by video wall configuration software 116 and received at the video processor 104. See FIG. 16 for more details regarding an example video processor 104. For more details regarding an example video processor 104 that can be used in examples according to this disclosure, also see U.S. Pat. No. 8,482,573, which is incorporated herein by reference in its entirety.

By sending commands to a video processor 104 from the computer 102 and implementing the configuration of the video wall source 106, 108, 110 through the video processor 104, the video canvas 112 or 114 can be altered live (e.g., in real-time) by a user through the video wall configuration software 116 with little to no appreciable effect on quality or virtually persistent display of video source(s) on the video wall(s).

The source 106, 108, or 110 can be a device or component capable of creating or transporting a video signal, such as a projector, a cable or network broadcast video source, a Digital Video Disc (DVD) or Blu-Ray disc player, a digital media server, or other example video sources. Sources 106, 108, or 110 or the displays 116 or 118 can be communicatively coupled to the video processor 104 by a variety of media including, for example, coaxial cable, an Ethernet connection, such as Category five cable, a High Definition Multimedia Interface (HDMI) cable, or S-Video cable. Similarly, the computer 102 can be communicatively connected to the video processor 104 by a variety of media and configured to communicate over such media by a variety of protocols, including, for example, an Ethernet connection or a serial or parallel connection. The computer 102 can also be an input to the video processor so that the computer 102 provides video data to the video processor 104.

The video canvas 112 or 114 can include one or more displays 118 or 120. The video (e.g., Full-Motion Video (FMV) or an image, such as still image) displayed on the video canvas 112 or 114 can be video from the source 106, 108, or 110 that is configured by the video processor 104 as a function of the commands from the video wall configuration software 116.

The display 118 or 120 can be a television or computer monitor, a projector screen, a wall (e.g., a blank or substantially flat wall), or other device capable of displaying video or having video displayed thereon.

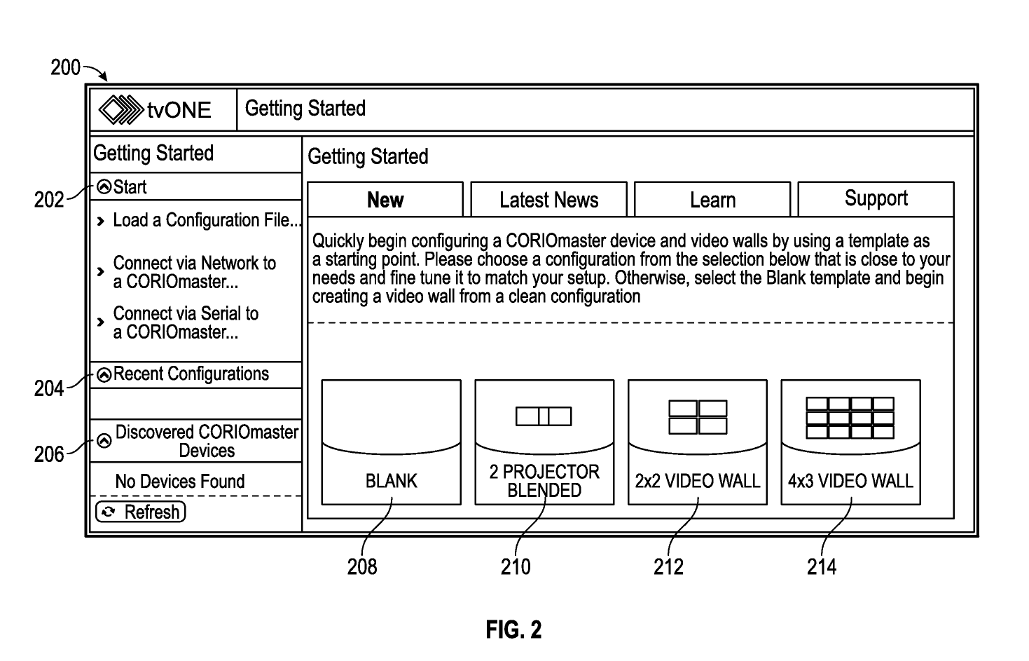

FIG. 2 illustrates an example of a Graphical User Interface (GUI) 200 of a program for configuring a video wall (e.g., video wall configuration software 116). The GUI 200 can include a start menu 202 configured to help a user virtually set up a video canvas object, a recent configurations menu 204 configured to help a user load a video canvas object that was previously created, or a discover menu 206 that is configured to allow a user to select a video processor 104 that has been discovered (e.g., automatically) by the computer 102 or the video wall configuration software 116.

The start menu 202 can provide an interface that allows a user to load a configuration file that was previously created. The configuration file can include data that defines one or more video canvases or video canvas object configurations. The start menu 202 can provide an interface that allows a user to connect the video wall configuration software 116 to a video processor 104, such as to allow the video wall configuration software 116 to transmit one or more commands to the video processor 104. The connection to the video processor 104 can be through a network or other connection, such as an Ethernet or serial connection.

The GUI 200 can include one or more preconfigured video canvas configurations, such as a blank canvas configuration 208, a projector-blended configuration 210, a two-by-two display configuration 212, or a four-by-three display configuration 214, such as shown in FIG. 2. Other video canvas 114 configurations can be preconfigured and included in the initial GUI 200 display, such as shown in FIG. 2. In addition to default configurations provided by video wall configuration software 116 through the GUI 200, a user-defined video canvas configuration can be created, saved, and reused.

The projector-blended configuration 210 can include a video canvas that includes two or more projectors configured to project a single image on one display (e.g., a wall). The video wall configuration software 116 can alter the video signal from one or more projectors such that when the video image of the projector overlaps with a video image of another projector, the intensity, contrast, or color of the image on the display in the overlapping image is consistent with the areas of the image that do not overlap. Thus, the video wall configuration software 116 can allow a user to create a single, seamless image using multiple projectors.

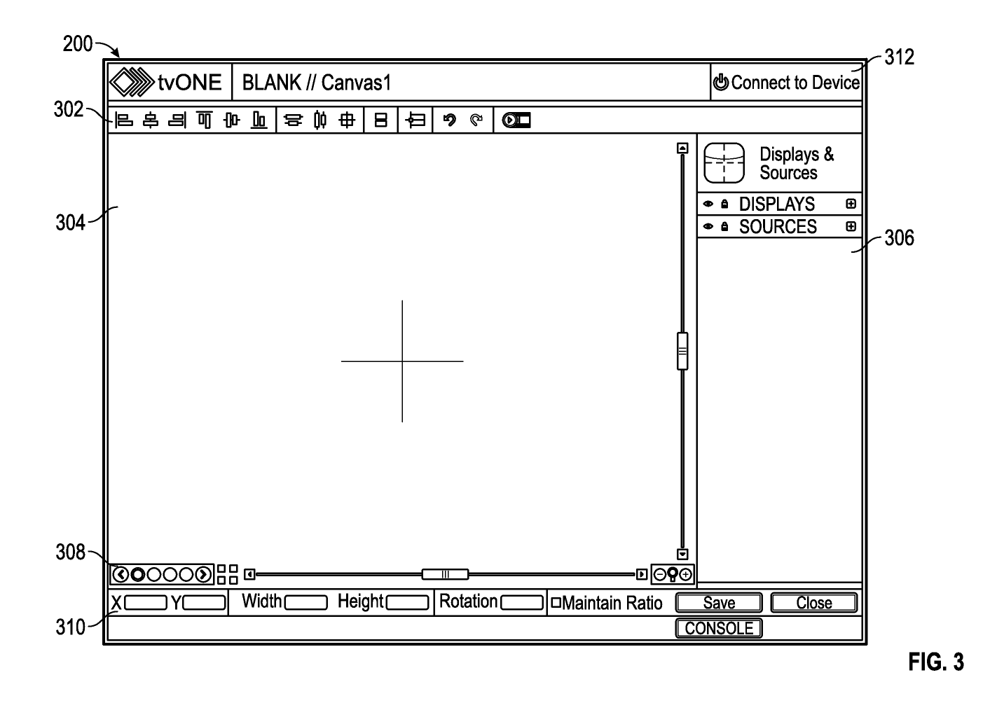

FIG. 3 illustrates an example of the GUI 200 showing a blank canvas configuration 208 on which a video canvas can be created. The GUI 200 can include a toolbar 302, a video canvas configuration box 304, a first display and source object summary and configuration toolbar 306, a video canvas indication object 308, a second display or source object configuration toolbar 310, or a connect to video processor button 312.

The toolbar 302 can include one or more buttons configured to alter an orientation of an active display object or source object in the canvas configuration box 304. In one or more embodiments, an active object is the object that was last selected or otherwise activated by a user. Multiple objects can be active at a given time, such as by selecting an object while the shift or control key is activated and another object is currently active. The button on the toolbar 302 can be configured to snap an active object to a grid in a specific orientation. Examples of actions that can be performed by selecting a button on the toolbar 302 can include aligning a left or right side of an object with a left side of another object, aligning a left or right side of an object with a right side of another object, aligning a top or bottom side of an object with a top or bottom side of another object, aligning an object center (e.g., a vertical or horizontal center) with another object center.

The button on the toolbar 302 can include a button that, when activated, alters a dimension of an activated display object or source object. The button can alter the length or width of the display object or source object to be the same as another display or source object.

The button on the toolbar 302 can include a redo or undo button, that when activated either takes back the most recent change made to an object (e.g., a source object, display object, or a video canvas object) or re-perform an operation that was taken back. The button on the toolbar 302 can include a preview or test button that provides video on a display object in the video canvas box that includes a source object situated thereon. This button can provide a user the ability to see what a video canvas 112 or 114 will look like before actually implementing the source 106, 108, or 110 on the video canvas 112 or 114 in the configuration currently shown in the canvas configuration box 304.

The canvas configuration box 304 can provide a user a space in which to configure a video canvas object. A user can drag and drop a source object or a display object in the canvas configuration box 304. The user can alter the size of a display object or source object in the canvas configuration box 304, such as by clicking and dragging an edge of the object. The aspect ratio of the source object can be retained or altered, such as by activating or deactivating a maintain aspect ratio mode option in the configuration toolbar 310.

The configuration toolbar 306 can provide an interface through which a user can add or configure a display object or source object. As used herein, a video canvas object can include a source object or a display object configured by a user, such as in the canvas configuration box 304. The configuration toolbar 306 can include a display object menu or a source object menu. Using the display object menu the user can configure an active display object or add a display object to the canvas configuration box 304. Using the source object selection menu the user can configure an active source object or add a source object to the canvas configuration box 304.

The video canvas indication object 308 can provide a user a visual indicator of which video canvas object is currently being displayed in the canvas configuration box 304. A graphical representation of the video canvas object can be displayed in the canvas configuration box 304 in response to a user selecting an indicator of the indication object 308.

The display or source object configuration toolbar 310 can provide a user the ability to adjust a configuration of an active display object or source object in the canvas configuration box 304. A display object or source object in the canvas configuration box 304 can have its height, width, or orientation altered by a user entering a number into a respective height, width, or rotation input box of the configuration toolbar 310. The configuration toolbar 310 can include a checkbox that indicates whether to maintain an aspect ratio of an active source object.

The connect video processor button 312 can provide a user with the ability to connect a video processor to the video wall configuration software 116 (e.g., for altering a video canvas in real-time). The video processor can be a previously undiscovered video processor.

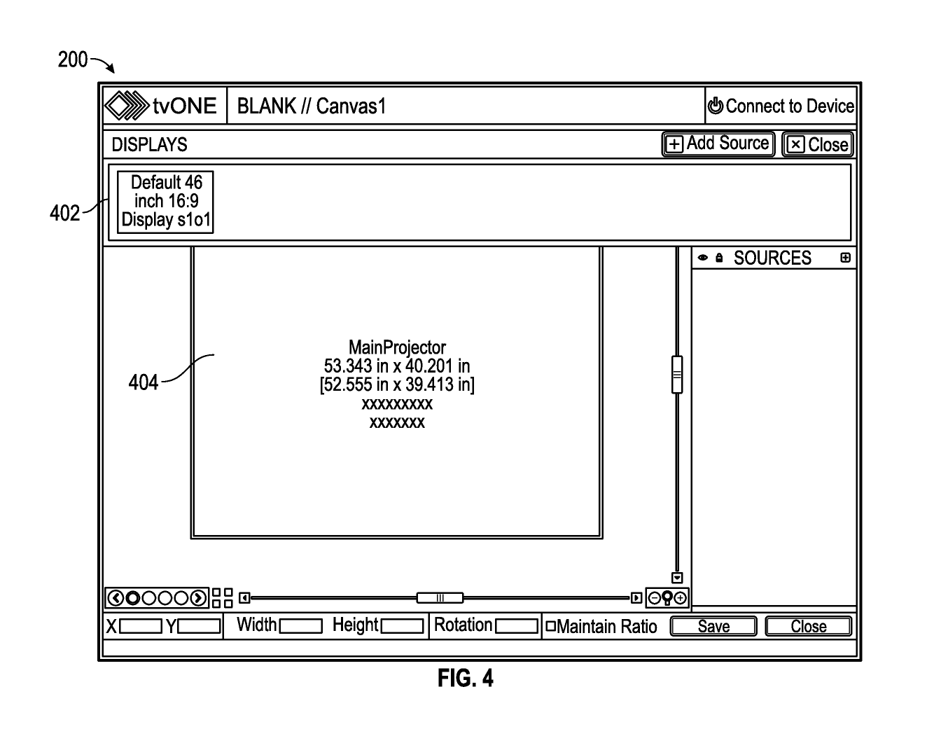

FIG. 4 illustrates an example of a GUI 200 of a program for configuring a video wall (e.g., video wall configuration software 116) that includes a display object 404 situated in the canvas configuration box 304. The display object 404 can correspond to a physical display 118 or 120. The display object 404 can be dragged and dropped onto the canvas configuration box 304 from a display object toolbar 402. The display object toolbar 402 can be displayed so as to be accessible by a user that activates the display object menu of the configuration toolbar 306. An add display button can be accessible by a user that activates the display object menu of the configuration toolbar 306. The display object toolbar 402 can include a stored library of default or user-defined display objects, from which a user can select and keep or modify the default configuration.

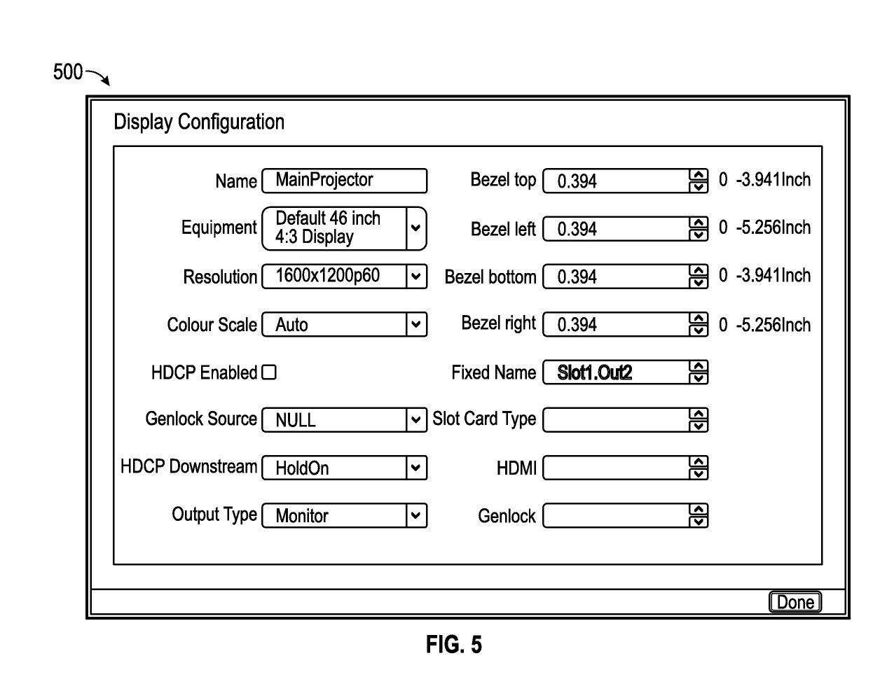

FIG. 5 illustrates an example of a configuration screen 500, such as can be presented using the video wall configuration software 116, including inputs for configuring a display object in the canvas configuration box 304. The configuration screen 500 can include input or check boxes to configure the display object 404. A user can configure the display object 404 to be consistent with the configuration of a display on a video canvas being controlled by a video processor to which video wall configuration software 116 is connected. A user can configure a name, equipment description, resolution, or colour scale of the display object. A user can configure whether the display object 404 is High-bandwidth Digital Content Protection (HDCP) enabled, an output type of the display object 404, or a bezel size on top, left, bottom, or right of the display object 404. A user can configure which output port of the video processor 104 the display 118 or 120 corresponding to the display object 404 is connected to.

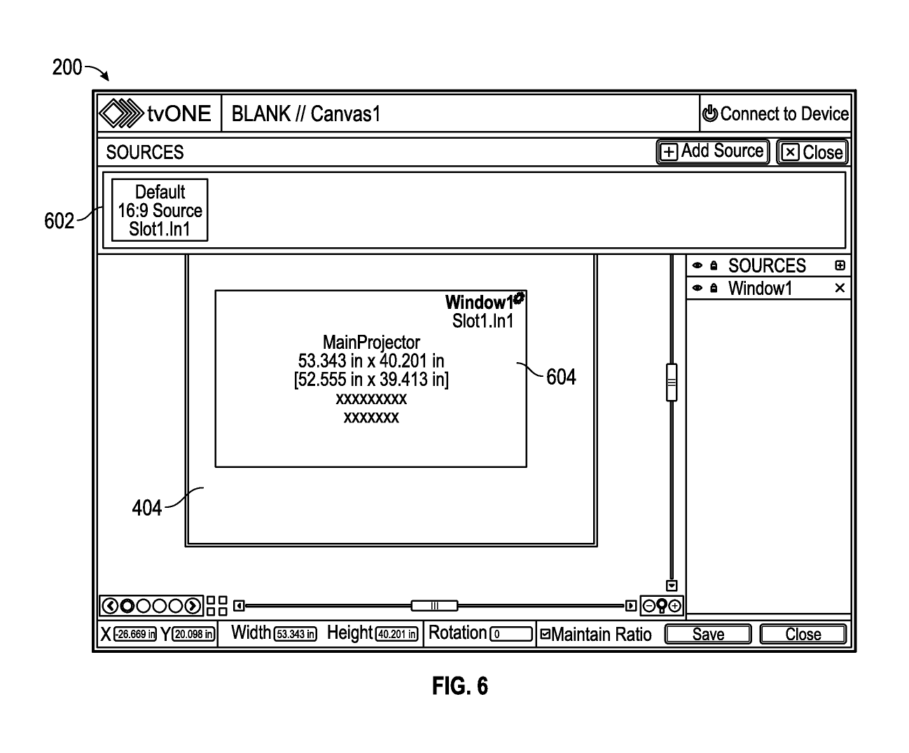

FIG. 6 illustrates an example of the GUI 200 of FIG. 4 with a source object 604 situated on the display object 404. The source object 604 can correspond to an actual video source (e.g., one of sources 108, 110, or 112 of FIG. 1). The source object 604 can be dragged and dropped onto the canvas configuration box 304 from a source object configuration toolbar 602. The source object configuration toolbar 602 can be displayed so as to be accessible by a user that activates the source object menu of the configuration toolbar 306. An add source button can be accessible by a user that activates the source object menu of the configuration toolbar 306. The source object configuration toolbar 602 can include a stored library of default or user-defined source objects, from which a user can select and either keep or modify.

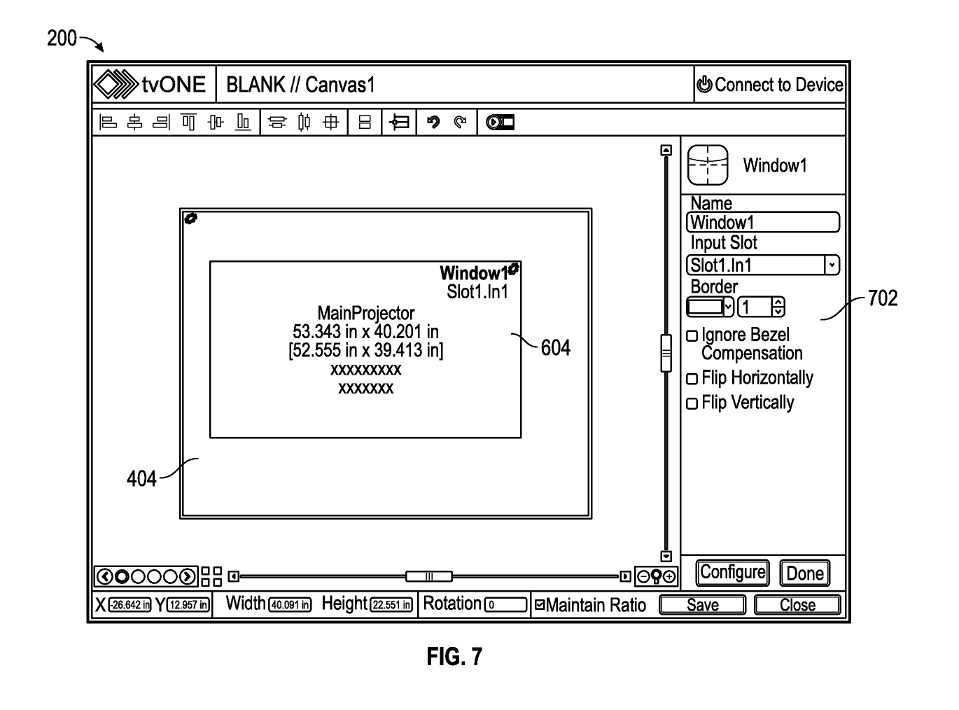

FIG. 7 illustrates an example of the GUI 200 after the source object 604 has been selected. By selecting the source object 604, a user can view a source object configuration toolbar 702. The source object configuration toolbar 702 can include a summary of the configuration of the source object 604. The source object configuration toolbar can provide a user the ability to enable or disable bezel compensation or flip the source object 604 horizontally or vertically. Some displays include an area around the periphery thereof where no video image is displayed; this area is referred to as the bezel. Bezel compensation allows the images rendered on multiple displays to compensate for the bezel such that an image appears seamless across the multiple displays.

The source object configuration toolbar 702 can provide a user the ability to configure the source object, such as by activating a configure button of the source object configuration toolbar 702.

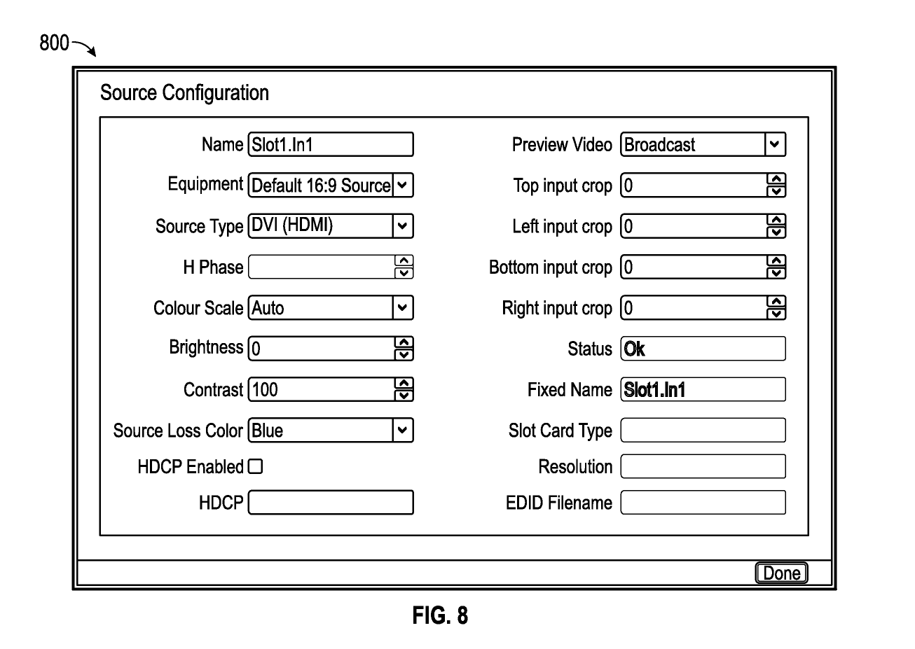

FIG. 8 shows a source object configuration screen 800 configured to allow a user to configure an active source object in the canvas configuration box 304. The source object configuration screen 800 can include an input or check box to allow a user to configure a name of the source object 604, equipment details of the source object 604, a type of the source object 604, or a phase of the source object 604. A user can configure a colour scale, brightness, contrast, or source loss of the source object 604, such as by entering values into an input box of the source object configuration screen 800. The user can indicate whether the source 106, 108, or 110 corresponding to the source object 604 is HDCP enabled. The source object configuration screen 800 can provide a user the ability to define a preview video type for the source object 604 or alter a top, bottom, left, or right crop of the source object 604.

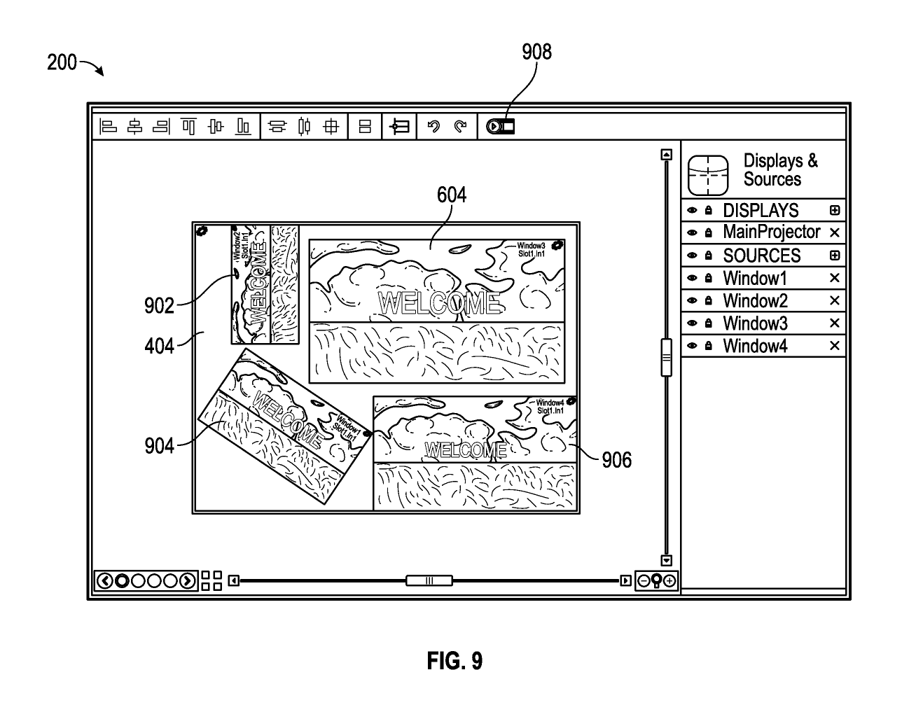

FIG. 9 illustrates an example of the GUI 200 with a single display object 404 and four source objects 604, 902, 904, and 906 situated on the display object 404. The four source objects 604, 902, 904, and 906, are each configured to have different sizes and orientations. The source object 902 can be oriented vertically, the source object 904 and 906 can be oriented horizontally, and the source object 904 can be oriented about 45 degrees from horizontal. While each source object 904 is shown as having the same source input (i.e. in this case the “WELCOME” screen) different source inputs can be simulated using the video wall configuration software 116 and the actual video sources represented by the source objects 604, 902, 904, and 906 can be a number of different types of video (e.g., a sporting event, news, network or cable television broadcast, etc.).

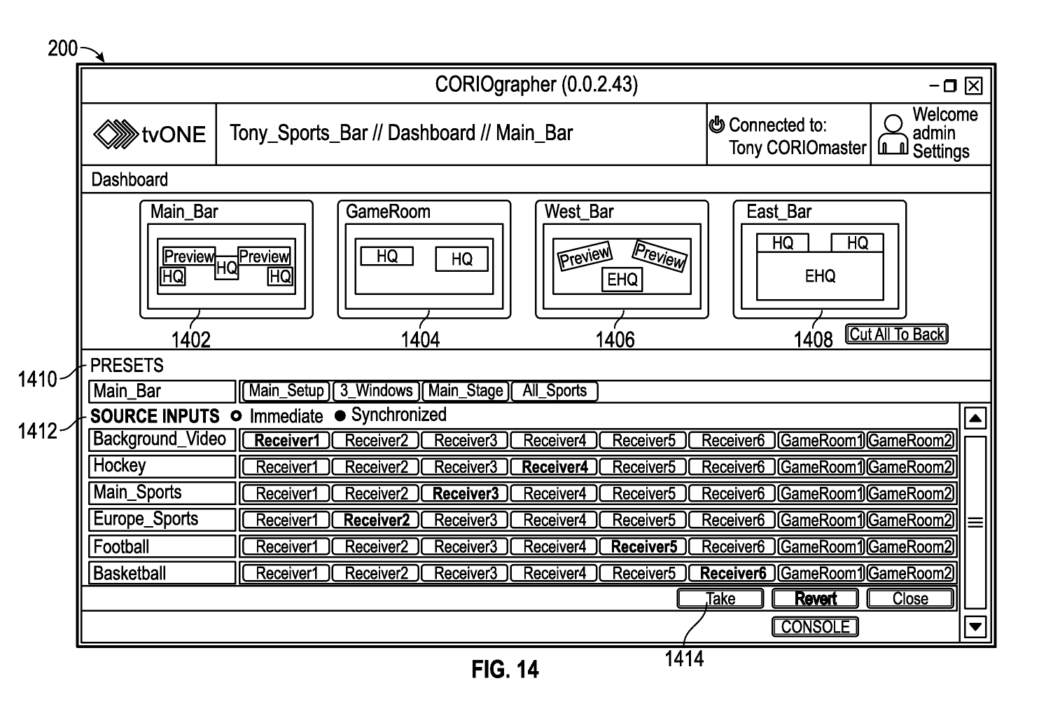

A user can alter the source (e.g., sources 106, 108, or 110) orientation or other configuration on a display (e.g., displays 118 or 120) in real-time by altering a corresponding source object 604, 902, 904, or 906 in GUI 200 and then selecting a “submit” or, in the context of live video wall controls, a “take” button included in GUI 200 (see FIG. 14 for an example of a “take” input control (e.g., button)). In response to selecting the take button, the video wall configuration software 116 can send commands to a video processor (e.g., the video processor 104) which cause the video processor 104 to implement the configuration of the source object 604, 902, 904, or 906 defined by the user through the video wall configuration software 116 on an actual video canvas including a corresponding number of actual video sources.

The commands transmitted to the video processor 104 can include text based commands that can be rapidly transmitted and interpreted by the video processor 104. The video processor 104 can then implement the configuration command from the configuration software 116 rapidly enough that changes on the actual video canvas viewed by an audience appears to happen instantaneously, or in “real-time”. In this manner, the source object 604, 902, 904, and 906 configuration as selected by the user, such as the configuration shown in FIG. 9, can be implemented in real-time on the display 118 or 120 in response to a user activating the take button. Alternatively, if an “Immediate” mode is selected by a user, the changes made to a source object 604, 902, 904, or 906 can be implemented in real-time on the video canvas 112 or 114, such as when the video canvas 112 or 114 is associated with the source object that is being altered.

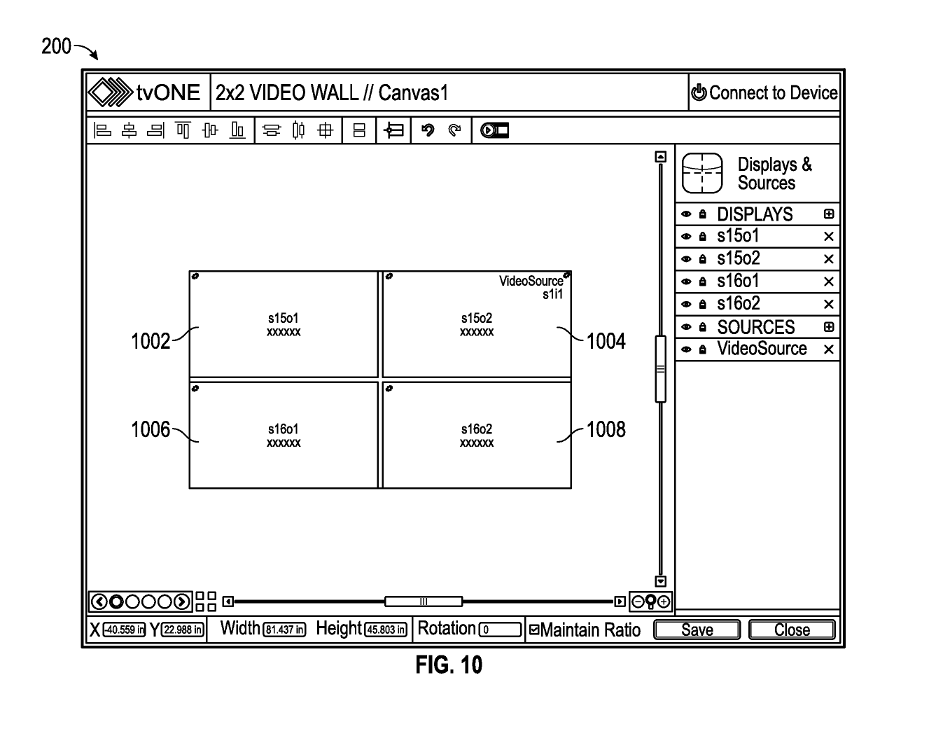

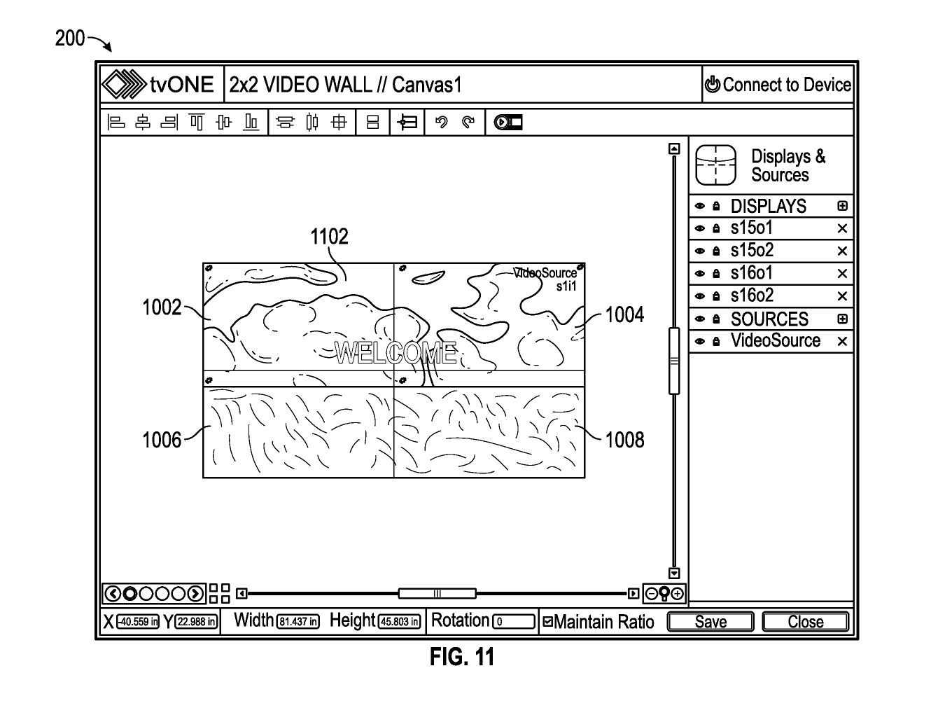

FIG. 10 illustrates an example of the GUI 200 with four display objects 1002, 1004, 1006, and 1008 situated in the video canvas configuration box 304. The display object 1002, 1004, 1006, or 1008 can be configured so as to effectively form a single larger display, as illustrated in the example of FIG. 11.

FIG. 11 illustrates the example GUI 200 of FIG. 10 with a single source object 1102 configured to be displayed across all four display objects 1002, 1004, 1006, and 1008 with bezel compensation. Bezel compensation can be disabled using the configuration toolbar 306.

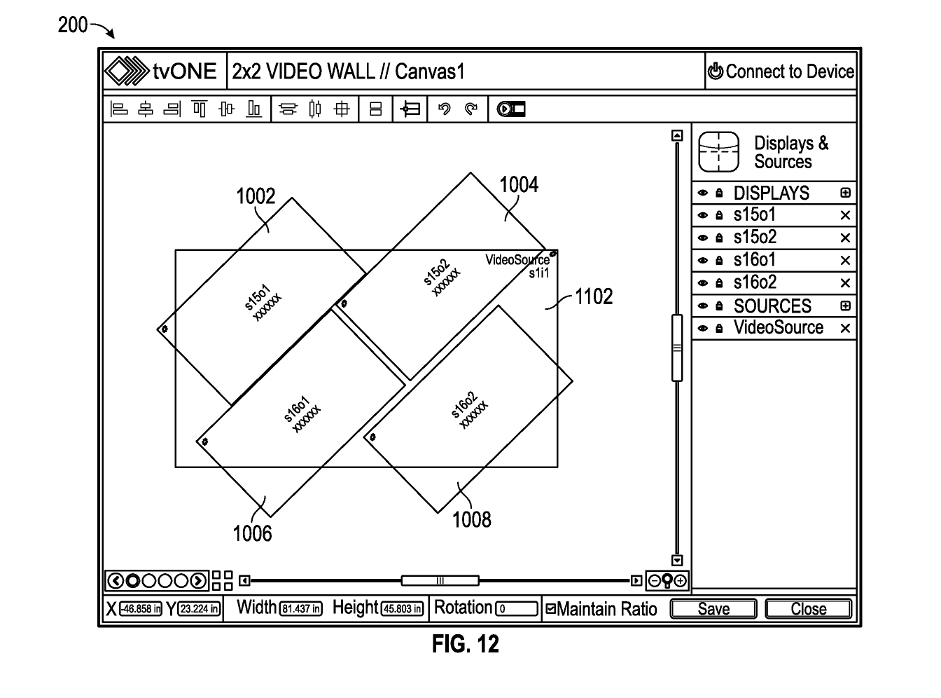

FIG. 12 illustrates an example of the GUI 200 of FIG. 11 with the single source object 1102 situated on the four display objects 1002, 1004, 1006, or 1008. Each of the display objects 1002, 1004, 1006, and 1008 is rotated from horizontal in the example of FIG. 12.

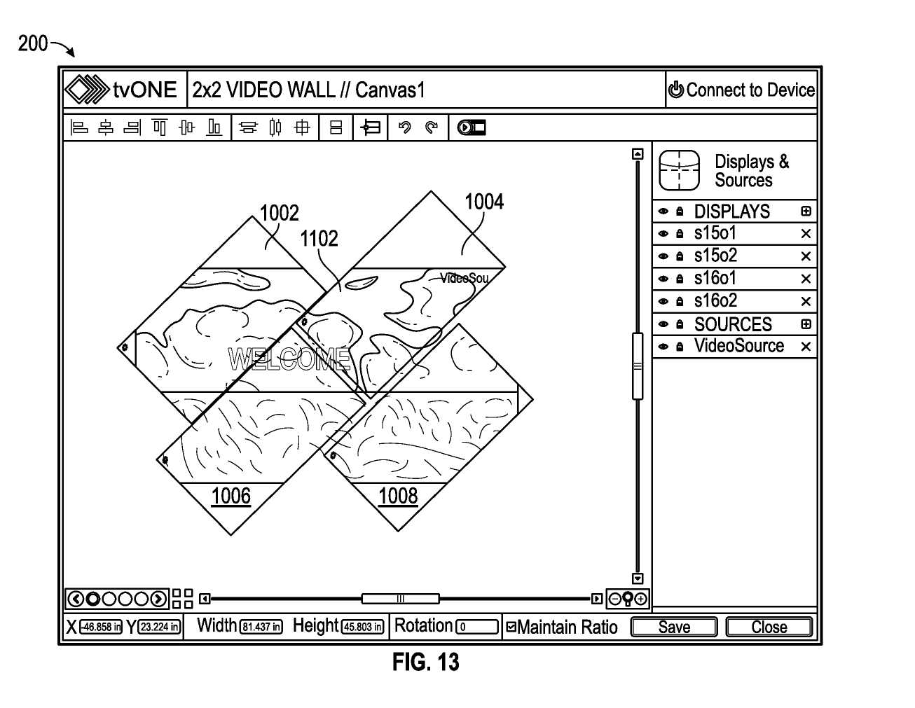

FIG. 13 illustrates the GUI 200 of FIG. 12 after the preview button has been activated. FIG. 13 demonstrates how the video wall configuration software 116 can provide a user with a view of what a video canvas 112 or 114 would look like if physically implemented. A user can manually adjust a display 118 or 120 to be situated in the same orientation or configuration as a corresponding display object 1104, 1106, 1108, or 1110. The display 118 or 120 can be physically coupled to the video processor 104. The video wall configuration software 116 can allow a user to associate the display 118 or 120 with a display object 1002, 1004, 1006, 1008, or other display object. When the user activates the take button or when a change is made using the video wall configuration software 116 in “Immediate” mode, the display 118 or 120 can provide a view of the video from the source 108, 110, or 112 that is associated with a source object 1102 that is on the associated display object 1002, 1004, 1006, 1008, or other display object in GUI 200 of video wall configuration software 116.

FIG. 14 shows the GUI 200 after the user has selected a dashboard view button. The GUI 200 in dashboard mode can include a summary of video canvas objects 1402, 1404, 1406, and 1408 that are associated with one or more video processors. The video canvas object 1402, 1404, 1406, and 1408 can include one or more preset configurations 1410. In the example shown in FIG. 14, the preset configuration 1410 for the video canvas object titled “Main_Bar” includes four preset configurations 1410, namely “Main_Setup”, “3_Windows”, “Main_Stage”, and “All_Sports”. The preset configuration 1410 can be a preconfigured video canvas object created by a user that can be implemented using the video canvas 112 or 114. When a user activates a preset configuration 1410, such as “Main_Setup” the video canvas object 1402 can display a summary in the GUI 200 of what will be displayed on the associated actual video canvas 112 or 114. If the user selects the take button 1414, the most recently selected preset configuration 1410 can be implemented in the associated video canvas 112 or 114, such as by sending the appropriate text configuration commands to the video processor 104 which is capable of switching the configuration of the actual video canvas 112 or 114 to the “Main_Setup” preset configuration in real-time.

The dashboard view can include a summary of source inputs 1412 for an active video canvas object 1402. The source inputs 1412 can summarize the display objects of the video canvas object 1402 and can summarize the actual source connections or inputs available to be routed to the display associated with the display object. In the example of FIG. 14, the “Main_Bar” video canvas has six displays and each display can be coupled to one or more of eight sources. In the example of FIG. 14, each display object of the “Main_Bar” video canvas is coupled to a different source object of the source inputs, thus each actual display of the actual “Main_Bar” video canvas is showing a different video source.

When an “Immediate” mode is selected, a change made to the video canvas object 1402, 1404, 1406, or 1408 is implemented on an associated video canvas (e.g., video canvas 112 or 114) instantaneously or in real-time. When the “Synchronized” mode is selected, a change made to the video canvas object 1402, 1404, 1406, or 1408 may not be implemented on the associated video canvas until after the user selects (e.g., activates) the take button 1414. Thus, if the “Immediate” mode is selected and the user selects the “3_Windows” preset configuration 1410, the video canvas associated with the “Main_Bar” video canvas object will begin displaying video using the “3_Windows” preset immediately (e.g., in real-time) after the user selects the preset configuration 1410. Similarly, the user can alter, such as in real-time, the source input 1412 by selecting a source input 1412 that is not already selected, when the “Immediate” mode is selected.

Alternatively, if the “Synchronized” mode is selected and the user selects “Receiver2” as a source for the “Football” display, the display (e.g., display 118 or 120) associated with the “Football” display object will not show the video associated with the “Receiver2” source until the user selects the take button 1414.

The preset configuration 1410 can be edited and the edits made to the preset configuration 1410 can be implemented in real-time on the associated video canvas 112 or 114, such as after the take button 1414 is selected or as the preset configuration 1410 is edited if the “Immediate” mode is selected.

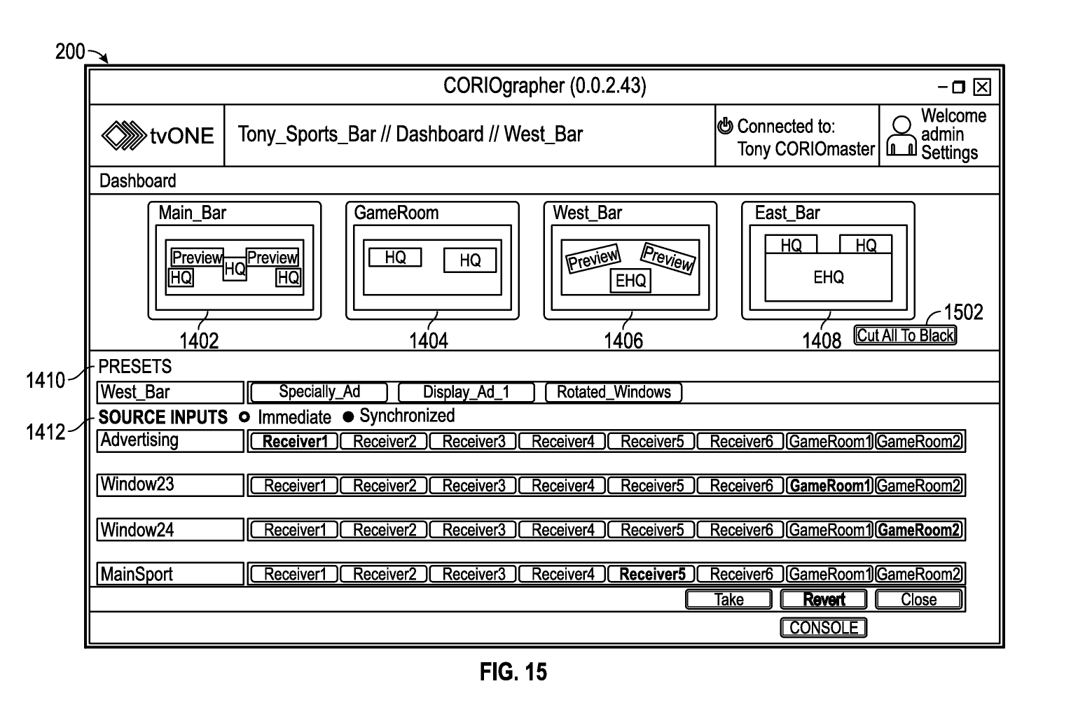

FIG. 15 illustrates the GUI 200 of FIG. 14 with the video canvas object 1406 selected. The video canvas object 1406 in the example of FIG. 15 includes three preset configurations 1410, four associated displays, and eight associated source inputs 1412.

The GUI 200 can include a button 1502 configured to turn all displays coupled to the video processor 104 to black when the button 1502 is selected. The button 1502 can be useful in a situation, such as a concert, where the video canvas is supposed to be blank or black until the concert begins, or whenever all the displays associated with the video canvas object 1406 are to be blank or black.

FIG. 16 illustrates a block diagram of an example of the video processor 104. The video processor 104 can include a source video configuration module 1604 or a router module 1606. The signal line 1602 can transport a command signal from the video wall configuration software 116 to the source video configuration module 1604 or the router module 1606.

A signal line 1608, 1610, and 1612 can be coupled to a respective source input (e.g., source 106, 108, or 110). The source video configuration module 1604 can alter the video data received on signal lines 1608, 1610, or 1612 in accord with the command received on the signal line 1602. In this manner, a user configuring a source object in the video wall configuration software 116 can send a command to the source video configuration module 1604 to alter the appearance of the source video received from the signal line 1608, 1610, or 1612.

The signal line 1614, 1616, or 1618 can be coupled to a respective display(s) (e.g., display 118 or 120). The router module 1606 can receive data from the source video configuration module 1604 and route the altered video signal to the signal line 1614, 1616, or 1618 in accord with a command received on the signal line 1602. In this manner, a user configuring a source object in the video wall configuration software 116 can send a command to the router module 1606 to (1) alter which display video data from a source appears on or (2) alter a configuration of the video data from the source on the display.

FIG. 17 illustrates a flow diagram of an example of a technique 1700. At 1702, a video canvas object can be configured, such as by a user operating the video wall configuration software 116. At 1704, the command can be received, such as at the video processor. At 1706, a video canvas can be configured in accord with the command. The video canvas can be configured using the video processor. The video canvas can be configured such that the video canvas appears as the video canvas object appears on the computing device. The technique 1700 can include transmitting a command indicative of the configuration of the video canvas object. The command can be transmitted to the video processor using the computing device. The video processor can be separate from and communicatively coupled to the computing device.

The video canvas object can include one or more video source objects representing one or more video sources connected as inputs to the video processor. The video canvas object can include one or more display device objects representing one or more display devices connected as outputs to the video processor. At least one of the one or more video source objects of the video canvas object can include a plurality of video source objects or the one or more display device objects of the video canvas object can include a plurality of display device objects.

The video processor can be coupled to at least one source input and the video canvas can include at least one display device. The technique 1700 can include altering, such as by using the video processor, the at least one source input in accord with the command. The technique 1700 can include transmitting, such as by using the video processor, the altered first source input to the at least one display such that the altered source input appears to change immediately (e.g., in real-time, nearly instantaneously) after the command is transmitted the video processor.

FIG. 18 illustrates a block diagram of an example machine 1800 upon which any one or more of the techniques (e.g., methodologies) discussed herein may perform. In alternative embodiments, the machine 1800 may operate as a standalone device or may be connected (e.g., networked) to other machines. In a networked deployment, the machine 1800 may operate in the capacity of a server machine, a client machine, or both in server-client network environments. In an example, the machine 1800 may act as a peer machine in peer-to-peer (P2P) (or other distributed) network environment. The machine 1800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 1800 may include a hardware processor 1802 (e.g., a central processing unit (CPU), a graphics processing unit (GPU), a hardware processor core, or any combination thereof), a main memory 1804 and a static memory 1806, some or all of which may communicate with each other via an interlink (e.g., bus) 1808. The machine 1800 may further include a display unit 1810, an alphanumeric input device 1812 (e.g., a keyboard), and a user interface (UI) navigation device 1814 (e.g., a mouse). In an example, the display unit 1810, input device 1812 and UI navigation device 1814 may be a touch screen display. The machine 1800 may additionally include a storage device (e.g., drive unit) 1816, a signal generation device 1818 (e.g., a speaker), a network interface device 1820, and one or more sensors 1821, such as a global positioning system (GPS) sensor, compass, accelerometer, or other sensor. The machine 1800 may include an output controller 1828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1816 may include a machine readable medium 1822 on which is stored one or more sets of data structures or instructions 1824 (e.g., software) embodying or utilized by any one or more of the techniques or functions described herein. The instructions 1824 may also reside, completely or at least partially, within the main memory 1804, within static memory 1806, or within the hardware processor 1802 during execution thereof by the machine 1800. In an example, one or any combination of the hardware processor 1802, the main memory 1804, the static memory 1806, or the storage device 1816 may constitute machine readable media.

While the machine readable medium 1822 is illustrated as a single medium, the term “machine readable medium” may include a single medium or multiple media (e.g., a centralized or distributed database, and/or associated caches and servers) configured to store the one or more instructions 1824.

The term “machine readable medium” may include any medium that is capable of storing, encoding, or carrying instructions for execution by the machine 1800 and that cause the machine 1800 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having resting mass. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1824 may further be transmitted or received over a communications network 1826 using a transmission medium via the network interface device 1820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1820 may include one or more physical jacks (e.g., Ethernet, coaxial, or phone jacks) or one or more antennas to connect to the communications network 1826. In an example, the network interface device 1820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1800, and includes digital or analog communications signals or other intangible medium to facilitate communication of such software.

### ADDITIONAL NOTES AND EXAMPLES

The present subject matter may be described by way of several examples.

Example 1 can include or use subject matter (such as an apparatus, a method, a means for performing acts, or a device readable memory including instructions that, when performed by the device, can cause the device to perform acts), such as can include or use (1) a video processor that processes video source data for display on a video display devices, (2) a video canvas including one or more video sources connected as inputs to the video processor, or one or more display devices connected as outputs to the video processor, wherein at least one of the one or more video sources of the video canvas comprises a plurality of video sources or the one or more display devices of the video canvas comprises a plurality of display devices, or (3) a computing device separate from and communicatively connected to the video processor, the computing device comprising a memory and a processor, the memory including instructions stored thereon, which when executed by a processor, cause the processor to generate a video canvas object representing the video canvas, or transmit configuration data to the video processor representing a configuration of the video canvas object, wherein the video processor controls the one or more display devices to display the one or more sources based on the configuration data.

Example 2 can include or use, or can optionally be combined with the subject matter of Example 1, to include or use wherein the configuration data comprises text data.

Example 3 can include or use, or can optionally be combined with the subject matter of at least one of Examples 1-2, to include or use wherein the configuration data indicates a change in the orientation of the one or more video sources relative to the one or more display devices.

Example 4 can include or use, or can optionally be combined with the subject matter of at least one of Examples 1-3, to include or use, wherein (1) the one or more video sources includes a plurality of video sources, (2) the one or more display devices includes one display device, (3) the video canvas object includes a plurality of source objects, each source object associated with a video source of the plurality of video sources, (4) the video canvas object includes one display object associated with the one display device, or (5) the configuration data reflects a change made to a source object of the plurality of source objects.

Example 5 can include or use, or can optionally be combined with the subject matter of at least one of Examples 1-3, to include or use wherein (1) the one or more video sources includes one video source, (2) the one or more display devices includes a plurality of display devices configured to display the one video source as if the plurality of displays are a single display, (3) the video canvas object includes one source object, the source object associated with the one video source, (4) the video canvas object includes a plurality of display objects, each display object associated with a display device of the plurality of display devices, or (5) the configuration data reflects a change made to the source object relative to the plurality of display objects.

Example 6 can include or use, or can optionally be combined with the subject matter of at least one of Examples 1-3, to include or use wherein (1) the one or more video sources include a first projector and a second projector, (2) the one or more display devices includes a projector screen, or (3) the video processor blends edges of the first and second projectors so as to make the first and second projectors appear on the projector screen as if they are transmitted from a single projector.

Example 7 can include or use, or can optionally be combined with the subject matter of at least one of Examples 1-6, to include or use wherein the video processor is configured to alter the one or more video sources in accord with the configuration data and control the one or more display devices such that the one or more altered video sources appear, to a user, to be displayed instantaneously on the one or more display devices.

Example 8 can include subject matter (such as an apparatus, a method, a means for performing acts, or a device readable memory including instructions that, when performed by the device, can cause the device to perform acts), such as can include or use (1) a video processor, (2) at least one video source coupled to an input of the video processor, (3) at least one video display coupled to an output of the video processor, or (4) a computing device separate from and communicatively coupled to the video processor, the computing device comprising a memory and a processor, the memory including instructions stored thereon, which when executed by the processor, cause the processor to (i) configure at least one video source object and at least one video display object, the at least one video source object associated with the at least one video source and the at least one video display object associated with the at least one video display, or (ii) transmit a command to the video processor, the command indicating a configuration of the at least one video source output and the at least one video display input. Example 8 can include or use wherein the video processor is configured to receive the command, alter the at least one video source in accord with the command, and output the altered video source on the at least one video display in accord with the command.

Example 9 can include or use, or can optionally be combined with the subject matter of Examples 8, to include or use, wherein the command is a text command.

Example 10 can include or use, or can optionally be combined with the subject matter of at least one of Examples 8-9, to include or use wherein the command indicates a change in the orientation of the at least one video source relative to the at least one video display.

Example 11 can include or use, or can optionally be combined with the subject matter of at least one of Examples 8-10, to include or use wherein the at least one video display includes a television monitor.

Example 12 can include or use, or can optionally be combined with the subject matter of at least one of Examples 8-11, to include or use wherein the at least one video source is a High Definition Multimedia Input (HDMI) source.

Example 13 can include or use, or can optionally be combined with the subject matter of at least one of Examples 8-10, to include or use wherein the at least one video source includes a first projector and a second projector, wherein the at least one video display includes a single projector screen, and wherein the command is for the video processor to blend edges of the first and second projectors for display on the single projector screen.

Example 14 can include or use, or can optionally be combined with the subject matter of at least one of Examples 8-13, to include or use the video processor is configured to receive the command, alter the at least one video source, and output the altered video source so that a time between receiving the command and outputting the altered video source appears to be instantaneous to a user.

Example 15 can include subject matter (such as an apparatus, a method, a means for performing acts, or a device readable memory including instructions that, when performed by the device, can cause the device to perform acts), such as can include or use (1) configuring, by a computing device, a video canvas object, (2) receiving, by a video processor separate from and communicatively coupled to the computing device, a command indicative of a configuration of the video canvas object, or (3) configuring, by the video processor, a video canvas in accord with the command such that the video canvas appears as the video canvas object appears on the computing device.

Example 16 can include or use, or can optionally be combined with the subject matter of Example 15, to include or use wherein the video canvas object includes one or more video source objects representing one or more video sources connected as inputs to the video processor, or one or more display device objects representing one or more display devices connected as outputs to the video processor, wherein at least one of the one or more video source objects of the video canvas object comprises a plurality of video source objects or the one or more display device objects of the video canvas object comprises a plurality of display device objects.

Example 17 can include or use, or can optionally be combined with the subject matter of at least one of Examples 15-16, to include or use wherein the video processor is coupled to at least one video source and the video canvas includes at least one video display, and the method includes altering, by the video processor, the at least one video source in accord with the command, or transmitting, using the video processor, the altered first video source to the at least one video display such that the altered video source appears to change immediately after the command is transmitted to the video processor.

Example 18 can include or use, or can optionally be combined with the subject matter of at least one of Examples 15-17, to include or use wherein receiving the command includes receiving a command to blend an edge of a first video source of the at least one video source with a corresponding edge of a second video source of the at least one video source and wherein configuring, by the video processor, the video canvas in accord with the command comprises blending, by the video processor, the edges of the first and second video sources so as to make the first and second video sources appear on a single projector screen as if they are transmitted from a single projector.

Example 19 can include or use, or can optionally be combined with the subject matter of at least one of Examples 15-18, to include or use wherein receiving the command includes receiving a plurality of commands to implement a video canvas preset of the video canvas object on a plurality of displays of the video canvas.

Example 20 can include or use, or can optionally be combined with the subject matter of at least one of Examples 15-18, to include or use wherein receiving the command includes receiving the command as a user alters, by the computing device, a video source object of the video canvas object.

Example 21 can include or use, or can optionally be combined with the subject matter of at least one of Examples 15-18, to include or use wherein receiving the command includes receiving the command in response to a user activating a take button, by the computing device.

The flowchart(s) and block diagram(s) in the FIGS. illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the FIGS. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above Description of Embodiments includes references to the accompanying drawings, which form a part of the detailed description. The drawings show, by way of illustration, specific embodiments in which methods, apparatuses, and systems discussed herein may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A system comprising:
a video processor that processes video source data for display on video display devices;
a video canvas comprising:
one or more video sources connected as inputs to the video processor; and
one or more display devices connected as outputs to the video processor,
wherein at least one of the one or more video sources of the video canvas comprises a plurality of video sources or the one or more display devices of the video canvas comprises a plurality of display devices; and
a computing device separate from and communicatively connected to the video processor, the computing device comprising a memory and a processor, the memory including instructions stored thereon, which when executed by a processor, cause the processor to:
generate a video canvas object representing the video canvas; and
transmit configuration data to the video processor representing a configuration of the video canvas object, wherein the video processor controls the one or more display devices to display the one or more sources based on the configuration data.

2. The system of claim 1, wherein the configuration data comprises text data.

3. The system of claim 1, wherein the configuration data indicates a change in the orientation of the one or more video sources relative to the one or more display devices.

4. The system of claim 1, wherein:
the one or more video sources includes a plurality of video sources,
the one or more display devices includes one display device,
the video canvas object includes a plurality of source objects, each source object associated with a video source of the plurality of video sources,
the video canvas object includes one display object associated with the one display device, and
the configuration data reflects a change made to a source object of the plurality of source objects.

5. The system of claim 1, wherein:
the one or more video sources includes one video source,
the one or more display devices includes a plurality of display devices configured to display the one video source as if the plurality of displays are a single display,
the video canvas object includes one source object, the source object associated with the one video source,
the video canvas object includes a plurality of display objects, each display object associated with a display device of the plurality of display devices, and
the configuration data reflects a change made to the source object relative to the plurality of display objects.

6. The system of claim 1, wherein
the one or more video sources include a first projector and a second projector,
the one or more display devices includes a projector screen, and
the video processor blends edges of the first and second projectors so as to make the first and second projectors appear on the projector screen as if they are transmitted from a single projector.

7. The system of claim 1, wherein the video processor is configured to alter the one or more video sources in accord with the configuration data and control the one or more display devices such that the one or more altered video sources appear, to a user, to be displayed instantaneously on the one or more display devices.

8. A system comprising:
a video processor;
at least one video source coupled to an input of the video processor;
at least one video display coupled to an output of the video processor;
a computing device separate from and communicatively coupled to the video processor, the computing device comprising a memory and a processor, the memory including instructions stored thereon, which when executed by the processor, cause the processor to:
configure at least one video source object and at least one video display object, the at least one video source object associated with the at least one video source and the at least one video display object associated with the at least one video display; and
transmit a command to the video processor, the command indicating a configuration of the at least one video source output and the at least one video display input;
wherein the video processor is configured to receive the command, alter the at least one video source in accord with the command, and output the altered video source on the at least one video display in accord with the command.

9. The system of claim 8, wherein the command is a text command.

10. The system of claim 8, wherein the command indicates a change in the orientation of the at least one video source relative to the at least one video display.

11. The system of claim 8, wherein the at least one video display includes a television monitor.

12. The system of claim 8, wherein the at least one video source is a High Definition Multimedia Input (HDMI) source.

13. The system of claim 8, wherein the at least one video source includes a first projector and a second projector, wherein the at least one video display includes a single projector screen, and wherein the command is for the video processor to blend edges of the first and second projectors for display on the single projector screen.

14. The system of claim 8, wherein the video processor is configured to receive the command, alter the at least one video source, and output the altered video source so that a time between receiving the command and outputting the altered video source appears to be instantaneous to a user.

15. A method comprising:
configuring, by a computing device, a video canvas object;
receiving, by a video processor separate from and communicatively coupled to the computing device, a command indicative of a configuration of the video canvas object; and
configuring, by the video processor, a video canvas in accord with the command such that the video canvas appears as the video canvas object appears on the computing device.

16. The method of claim 15, wherein:
the video canvas object comprises:
one or more video source objects representing one or more video sources connected as inputs to the video processor; and
one or more display device objects representing one or more display devices connected as outputs to the video processor, wherein at least one of the one or more video source objects of the video canvas object comprises a plurality of video source objects or the one or more display device objects of the video canvas object comprises a plurality of display device objects.

17. The method of claim 15, wherein the video processor is coupled to at least one video source and the video canvas includes at least one video display, the method further comprising:
altering, by the video processor, the at least one video source in accord with the command; and
transmitting, by the video processor, the altered first video source to the at least one video display such that the altered video source appears to change immediately after the command is transmitted to the video processor.

18. The method of claim 17, wherein receiving the command includes receiving a command to blend an edge of a first video source of the at least one video source with a corresponding edge of a second video source of the at least one video source and wherein configuring, by the video processor, the video canvas in accord with the command comprises blending, by the video processor, the edges of the first and second video sources so as to make the first and second video sources appear on a single projector screen as if they are transmitted from a single projector.

19. The method of claim 17, wherein receiving the command includes receiving a plurality of commands to implement a video canvas preset of the video canvas object on a plurality of displays of the video canvas.

20. The method of claim 15, wherein receiving the command includes receiving the command as a user alters, by the computing device, a video source object of the video canvas object.

21. The method of claim 15, wherein receiving the command includes receiving the command in response to a user activating a take button, by the computing device.
